(19) United States
(12) Patent Application Publication
(10) Pub. No.: US 2026/0304202 A1
(43) Pub. Date: Oct. 1, 2026

(54) METHODS AND SYSTEMS FOR IDENTIFYING AND CONFIGURING LR CAPABLE DEVICES IN DUAL RADIO SYSTEMS

(71) Applicant: Samsung Electronics Co., Ltd., Suwon-si (KR)

(72) Inventors: Shouvik GUHA, Bangalore (IN); Neha SHARMA, Bangalore (IN)

(21) Appl. No.: 19/637,717

(22) Filed: Apr. 2, 2026

Related U.S. Application Data
(63) Continuation of application No. PCT/KR2026/095307, filed on Mar. 27, 2026.

(30) Foreign Application Priority Data
Apr. 1, 2025 (IN) 202541032445
Feb. 23, 2026 (IN) 2025 41032445

(51) Int. Cl. H04W 28/02; H04L 5/00; H04W 76/15; H04W 76/27

(52) U.S. Cl. CPC H04W 28/0215; H04L 5/003; H04W 76/15; H04W 76/27

(57) ABSTRACT

Methods and systems for managing low-power radio (LR) capable devices in a dual radio operation in wireless communication networks are provided. The method includes transmitting, by a user equipment (UE), a UE capability information indicating support for the dual radio operation to a network, wherein the UE capability information comprises a low-power radio (LR) capability with at least one LR capability container, receiving, by the UE, an LR configuration message from the network, wherein the LR configuration message indicates an LR mode activation, activating, by the UE, an LR, upon receiving the LR configuration message indicating the LR mode activation, and operating, by the UE, at least a portion of one or more communication functions using the activated LR.

### CROSS-REFERENCE TO RELATED APPLICATION(S)

This application is a continuation application, claiming priority under 35 U.S.C. § 365(c), of an International application No. PCT/KR2026/095307, filed on Mar. 27, 2026, which is based on and claims the benefit of an Indian Provisional patent application number 202541032445, filed on Apr. 1, 2025, in the Indian Patent Office, and of an Indian Non-Provisional patent application number 202541032445, filed on Feb. 23, 2026, in the Indian Patent Office, the disclosure of each of which is incorporated by reference herein in its entirety.

### TECHNICAL FIELD

The disclosure relates to wireless communication networks. More particularly, the disclosure relates to managing Low-power Radio (LR) capable devices in a dual radio operation in wireless communication networks.

### BACKGROUND

For the next generation of wireless communication systems, sustainability has become a critical theme. With the increasing demand for wireless connectivity, it is essential to design systems that align with sustainable development goals. Sixth Generation (6G) of wireless communication systems is expected to play a significant role in achieving these goals by providing ultra-reliable, low-latency, and high-throughput connectivity while minimizing energy consumption and environmental impact.

In fifth generation (5G) networks, higher-layer protocols are optimized for a single radio link, which offers high throughput, but consumes significant energy. This approach may not be very optimal for operations or services that require very little data or are only needed for control plane purposes. The radio is a vital element of wireless devices (for example, smartphones, wearables, IoT devices, and so on). The radio facilitates wireless connectivity, which is crucial for enabling rich applications and ensuring a satisfactory standby time. However, high-performance radios that provide faster data rates tend to consume more power. Conversely, traditional methods that reduce radio power consumption often compromise performance. This creates a fundamental trade-off between performance and power savings in a single powerful radio design.

At present, no method exists in third generation partnership project (3GPP) to report Low-power Radio (LR) capabilities; for example,
LR capability which can be categorized based on operating frequency where, LR and Main Radio (MR) operates on same radio frequency (intra-LRMR), LR and MR operates on different radio frequency (inter-LRMR), or LR and MR operates on same and different radio frequency (both-Intra-Inter-LRMR);
LR capability which can be categorized based on supported procedures such as, but not limited to, an idle procedure (such as, but not limited to, synchronization signal block (SSB) decoding, system information block (SIB) monitoring, paging, and so on), a connected procedure (such as, but not limited to, measurement w/o gap, small data transmission, and so on), and an access procedure (such as, but not limited to, random access channel (RACH), and so on).
Additionally different LR capability may need different LR to MR and vice versa transition period, wherein the transitionTime-LRMR is reported in ms or number of physical downlink control channel (PDCCH) occasions; and
If network is aware of device capability, then the network may configure appropriate power saving configuration at user equipment (UE) via a radio resource control (RRC) reconfiguration procedure, and/or the network may not assign the Downlink Control Information (DCI) during the transition period.

The above information is presented as background information only to assist with an understanding of the disclosure. No determination has been made, and no assertion is made, as to whether any of the above might be applicable as prior art with regard to the disclosure.

### OBJECTS

Aspects of the disclosure are to address at least the above-mentioned problems and/or disadvantages and to provide at least the advantages described below. Accordingly, an aspect of the disclosure is to provide methods and systems for managing the interworking of low-power radio (LR), and main radio (MR) signaling in 5G beyond communication networks.

Another aspect of disclosure is to provide a dual-radio architecture for future generations of wireless communication systems, wherein the dual-radio architecture enables the interworking of LR and MR signaling in 6G communication networks.

Another aspect of disclosure is to provide mechanisms and signaling protocols to handle the switching between the MR and the LR.

Another aspect of disclosure is to provide methods and systems for providing a modified radio resource control (RRC) user equipment (UE) capability information (UCI) signaling, a modified RRC UE assistance information (UAI) signaling, and a modified RRC release signaling to notify the LR capable devices on the activated network energy saving features.

Additional aspects will be set forth in part in the description which follows and, in part, will be apparent from the description, or may be learned by practice of the presented embodiments.

### SUMMARY

In accordance with an aspect of the disclosure, a method for performing a dual radio operation by a user equipment (UE) in a wireless communication system is provided. The method includes transmitting, by a user equipment (UE), a UE capability information indicating support for the dual radio operation to a network, wherein the UE capability information comprises a low-power radio (LR) capability with at least one LR capability container, receiving, by the UE, an LR configuration message from the network, wherein the LR configuration message indicates an LR mode activation, activating, by the UE, the LR, based on receiving the LR configuration message indicating the LR mode activation, and operating, by the UE, at least a portion of one or more communication functions using the activated LR.

In accordance with an aspect of the disclosure, a user equipment (UE) is provided. The UE includes a transceiver configured to receive and transmit a signal, memory, comprising one or more storage media, storing instructions, and one or more processors communicatively coupled to the transceiver and the memory, wherein the instructions, when executed by the one or more processors individually or collectively, cause the UE to transmit a UE capability information indicating support for the dual radio operation to a network, the capability information comprises a low-power radio (LR) capability with at least one LR capability container, receive an LR configuration message from the network, wherein the LR configuration message indicates an LR mode activation, activate an LR, based on receiving the LR configuration message indicating the LR mode activation, and operate at least a portion of one or more communication functions using the activated LR.

In accordance with an aspect of the disclosure, one or more non-transitory computer-readable storage media storing one or more computer programs including computer-executable instructions that, when executed by one or more processors of an electronic device individually or collectively, cause the electronic device to perform operations are provided. The operations include transmitting, by a user equipment (UE), a UE capability information indicating support for the dual radio operation to a network, wherein the UE capability information comprises a low-power radio (LR) capability with at least one LR capability container, receiving, by the UE, an LR configuration message from the network, wherein the LR configuration message indicates an LR mode activation, activating, by the UE, an LR, based on receiving the LR configuration message indicating the LR mode activation, and operating, by the UE, at least a portion of one or more communication functions using the activated LR.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF FIGURES

The above and other aspects, features, and advantages of certain embodiments of the disclosure will be more apparent from the following description taken in conjunction with the accompanying drawings, in which:

FIG. 1 depicts a block diagram of a system for performing a dual radio operation in a wireless communication system, according to an embodiment of the disclosure;

FIG. 2 depicts a block diagram of a plurality of modules of a processor, according to an embodiment of the disclosure;

FIG. 3 depicts a method for performing the dual radio operation by a UE, according to an embodiment of the disclosure;

FIG. 4 depicts an example overview of the wireless communication network for performing the dual radio operation, according to an embodiment of the disclosure;

FIG. 5 depicts a method for indicating a UE LR capability, according to an embodiment of the disclosure;

FIG. 6 depicts a method for requesting the network to configure energy saving feature, according to an embodiment of the disclosure; and

FIGS. 7A and 7B depict methods for performing measurement in dual radio devices, according to various embodiments of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the embodiments, descriptions related to technical contents well-known in the art and not associated directly with the disclosure will be omitted. Such an omission of unnecessary descriptions is intended to prevent obscuring of the embodiments disclosed herein, and more clearly transfer the embodiments disclosed herein.

For the same reason, in the accompanying drawings, some elements may be exaggerated, omitted, or schematically illustrated. Further, the size of each element does not completely reflect the actual size. In the drawings, identical or corresponding elements are provided with identical reference numerals or different reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Furthermore, in describing the disclosure, a detailed description of known functions or constitution incorporated herein will be omitted in the case that it is determined that the description may make the subject matter of the disclosure unnecessarily unclear. The terms which will be described below are terms defined in consideration of the functions in the disclosure, and may be different according to users, intentions of the operators, or customs. Therefore, the definitions of the terms should be made based on the contents throughout the specification.

In the specific embodiments of the disclosure described below, terms or components included in the disclosure may be expressed in singular or plural form depending on the specific embodiments presented. However, such singular or plural expressions are selected appropriately for convenience of description, and the disclosure is not limited to a singular or plural number of components. A component expressed in the plural form may be implemented as a single component, and a component expressed in the singular form may be implemented as multiple components.

It is to be understood that the terminology used herein is for the purposes of describing particular embodiments only and is not intended to be limiting. The terms “comprising,” “having” and “including” are to be construed as open-ended terms unless otherwise noted.

Herein, it will be understood that each block of the flowchart illustrations, and combinations of blocks in the flowchart illustrations, may be performed based on computer program instructions. These computer program instructions may be loaded individually or collectively onto at least one processor of a general purpose computer, special purpose computer, or other programmable data processing apparatus to produce a machine, such that the instructions, which perform through any one of, or in any combination of, the at least one processor of the computer or other programmable data processing apparatus, create means for performing the functions specified in the flowchart block(s). These computer program instructions may also be stored in a non-transitory computer usable or computer-readable memory that may direct a computer or other programmable data processing apparatus to function in a particular manner, such that the instructions stored in the computer usable or computer-readable memory produce an article of manufacture including instruction means that perform the function specified in the flowchart block(s). The computer program instructions may also be loaded onto a computer or other programmable data processing apparatus to cause a series of operational steps to be performed on the computer or other programmable data processing apparatus to produce a computer executed process such that the instructions that perform on the computer or other programmable data processing apparatus provide steps for executing the functions specified in the flowchart block(s).

Further, each block may represent a module, segment, or portion of code, which includes one or more executable instructions for executing the specified logical function(s). It should also be noted that in some alternative implementations, the functions noted in the blocks may occur out of the order. For example, two blocks (or functions) shown in succession may in fact be performed substantially concurrently or the blocks may sometimes be performed in the reverse order, depending upon the functionality involved.

As used in embodiments of the disclosure, a “module” may refer to a software element or a hardware element, such as a field programmable gate array (FPGA) or an application specific integrated circuit (ASIC), which performs a predetermined function. However, the term including the word “module” does not always have a meaning limited to software or hardware. The “module” may be constructed either to be stored in an addressable storage medium or to execute one or more processors. Therefore, the “module” includes, for example, software elements, object-oriented software elements, components such as class elements and task elements, processes, functions, properties, procedures, sub-routines, segments of a program code, drivers, firmware, micro-codes, circuits, data, database, data structures, tables, arrays, and parameters. The components and functions provided by the “module” may be either combined into a smaller number of components and a “module,” or divided into additional components and a “module.” Moreover, the components and “modules” may be implemented to reproduce one or more central processing units (CPUs) within a device or a security multimedia card. Further, in the embodiments, the “module” may include one or more processors.

Any of the functions or operations described herein can be processed by one processor or a combination of processors. The one processor or the combination of processors is circuitry performing processing and includes circuitry like an application processor (AP, e.g. a CPU), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, microprocessors, microcontrollers, digital signal processors, FPGA, ASIC, a microprocessor unit (MPU), a system on chip (SoC), an IC, or the like. The one processor or the combination of processors executes instructions that can be stored in memory, such as the operating system, in order to control the overall operation of the device. Also, the one processor or the combination of processors is also capable of executing other processes and programs resident in the memory, such as processes for the disclosure.

The drawings or flowcharts described below illustrate example methods that may be implemented according to the principles of the disclosure, and various modifications may be made to the methods illustrated in the flowcharts of the disclosure. For example, although illustrated as a series of operations, various operations in each drawing or flowchart may overlap, occur in parallel, occur in a different order, or be repeated. In other examples, any operation may be omitted or replaced with another operation.

The process of the flowchart may be performed by a device. One or more of the operations of the flowchart can be implemented by one or more processors/computer programs executing instructions to perform the noted functions.

The methods and apparatuses proposed in the embodiments of the disclosure may be disclosed in connection with drawings disclosing flowcharts to illustrate example methods that may be implemented according to the principles of the disclosure. Such flowcharts may contain different branches and/or sub-branches. It is understood that the principles of the disclosure do not only contain the combination of all branches/sub-branches disclosed in the embodiment, but the disclosure also contains at least one isolated branch/isolated sub-branch, in particular to a single branch/single sub-branch.

The methods and apparatuses proposed in the embodiments of the disclosure are not limited to each embodiment individually, but may also be applied in combination of all or some of the embodiments proposed in the disclosure. Therefore, the embodiments of the disclosure may be modified and applied without significantly departing from the scope of the disclosure, as would be understood by those skilled in the art.

In this case, even if certain wordings are described differently across embodiments, they may be used interchangeably or in substitution or in combination if their underlying concepts are equivalent. For example, for the same or equivalent concept, even if one embodiment uses the expression “A” and another embodiment uses the expression “B,” such expressions may be understood interchangeably, in substitution, or in combination.

The terms used in the following description to refer to network, messages, interfaces between network, various types of identification information, and the like, are provided merely for the convenience of explanation by way of example. Therefore, the disclosure is not limited to the terms described below, and other terms having equivalent technical meanings may also be used. Such terms may also be interchangeable with terms defined in any 3rd generation partnership project (3GPP) technical specifications (TS) or similar technical specifications, e.g., from european telecommunications standards institute (ETSI), where appropriate.

Furthermore, hereinafter, 5th Generation (5G) mobile communication technologies (for example, 5G new radio (NR)), 6th generation (6G) mobile communication technologies may be described by way of example, but the embodiments of the disclosure may also be applied to other communication systems having similar technical backgrounds or channel types. For example, newly evolved mobile communication systems developed after 5G and 6G may be included. Furthermore, based on determinations by those skilled in the art, the embodiments of the disclosure may also be applied to other communication systems (e.g., Wi-Fi systems) through some modifications without significantly departing from the scope of the disclosure.

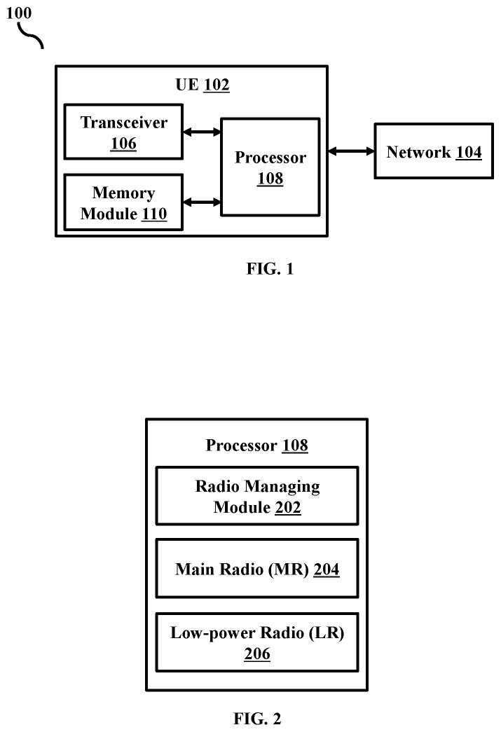

The embodiments herein achieve methods and systems for managing the interworking of low-power radio (LPR or LR) and main radio (MR) signalling in 5G beyond communication networks. Referring now to the drawings, and more particularly to FIGS. 1 to 6, 7A, and 7B, where similar reference characters denote corresponding features consistently throughout the figures, there are shown embodiments.

Embodiments herein disclose a dual-radio architecture for future generations of wireless communication systems with sustainability principles. Embodiments herein disclose mechanisms and signaling protocols to handle the switching between the MR, and the LR. Embodiments herein aim at reducing overall power consumption while maintaining satisfactory levels of performance, making it an ideal candidate for achieving sustainability goals in 5G beyond systems such as 6G systems.

Embodiments herein disclose the main radio (MR) responsible for handling demanding applications requiring high bandwidth and processing capabilities.

Embodiments herein disclose the low-power radio (LR), tasked primarily with managing connections and performing ancillary functions such as paging notifications, signal measurements, updating system parameters, and exchanging limited quantities of data packets. This division allows each component to operate efficiently within their respective domains, thereby minimizing unnecessary expenditure of resources and leading to substantial reductions in total energy usage across the entire infrastructure.

To effectively implement the dual-radio architecture, embodiments herein disclose mechanisms to perform switching between the two radios. These mechanisms include defining triggering conditions for various procedures, such as when the MR should switch to the LR or vice versa, and establishing a signaling mechanism to facilitate seamless switching between the two radios.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

FIG. 1 depicts a block diagram of a system 100 for performing a dual radio operation in a wireless communication system according to an embodiment of the disclosure. The system 100 comprises a user equipment (UE) 102, and a network 104. The UE 102 is an electronic device capable of wireless communication and having various form factors, examples of the UE 102 may include a mobile station (MS), a cellular phone, a smartphone, a computer, a tablet, a wearable device, an internet-of-things (IoT) device, or any other device/system capable of performing wireless communication with the network 104 and/or another UE or terminal through a wireless channel.

Referring to FIG. 1, the UE 102 may include at least one transceiver (hereinafter, referred to as simply “transceiver”) 106, at least one processor (hereinafter, referred to as simply “processor”) 108, and at least one memory module (hereinafter, referred to as simply “memory”) 110. According to at least one or a combination of methods corresponding to the embodiments described in the disclosure, the transceiver 106, the processor 108, and the memory 110 of the UE 102 may operate. However, components of the UE 102 are not limited to the example components illustrated in FIG. 1. In another embodiment, the UE 102 may further include additional components in addition to the above-mentioned components, or some components may be omitted. Further, in some embodiments, any combination of the transceiver 106, the processor 108, or the memory 110 may be integrated in the form of one component.

The transceiver 106 may be a communication circuit or communication circuitry that enables the UE 102 to perform wireless communication with a node or an entity of the network 104. For example, the transceiver 106 may enable the UE 102 to transmit or receive a signal to or from the network 104 through cellular communication, or to transmit or receive a signal to or from another UE through cellular communication. For example, the transceiver 106 may support at least one of various cellular communication technologies including 3rd Generation (3G), 4th Generation (4G), Long Term Evolution (LTE), 5th Generation (5G) New Radio (NR), 6th Generation (6G), and various cellular wireless communication technologies supported by the transceiver 106 may include all subsequent generations of evolved wireless communications.

In an embodiment herein, the transceiver 106 may include various circuit structures used to transmit or receive signals to or from the network 104 through a wireless channel. The signals may include control information and data. For example, the transceiver 106 may include a radio frequency (RF) transmitter for up-converting, and amplifying the frequency of a transmitted signal, and an RF receiver for low-noise-amplifying a received signal and down-converting the frequency thereof. The transceiver 106 may output a signal received through a wireless channel to the processor 108 and may transmit, through a wireless channel, a signal output from the processor 108.

In an embodiment herein, the UE 102 may include a plurality of transceivers. For example, in the case of supporting Evolved-Universal Terrestrial Radio Access-New Radio (E-UTRA-NR) Dual Connectivity (EN-DC), the UE 102 may include a first transceiver supporting the 4G LTE wireless communication and a second transceiver supporting the 5G NR wireless communication. According to another embodiment, in the case of supporting NR-Dual Connectivity (NR-DC), the UE 102 may include a plurality of transceivers supporting the 5G NR wireless communication. According to still another embodiment, in the case of supporting near field wireless communication, the UE 102 may separately include a transceiver supporting at least one standard in the group of wireless communication protocol standards as defined in the protocol standards for Bluetooth, Wireless Local Area Network (WLAN) network (including institute of electrical and electronics engineers (IEEE) 802.11-2016 standard or its amendments, e.g., 802.11ah, 802.11ad, 802.11ay, 802.11ax, 802.11az, 802.11ba, and 802.11be, without being limited thereto).

The processor 108 may control general operations of the UE 102 according to embodiments of the disclosure. The processor 108 may be implemented by one or more integrated circuit (or circuitry) (IC) chips and may execute various data processing operations. The processor 108 may include at least one electric circuit, and may execute instructions (or a program, codes, data, etc.) stored in the memory 110, individually, collectively or in any combination thereof. Further, the processor 108 may include a single-core processor or multi-core processor, and may include a processor assembly including a plurality of processing circuits (circuitry) according to a specific implementation scheme.

The processor 108 may be electrically, operatively, and/or communicatively coupled to the transceiver 106 to control the transceiver 106.

The processor 108 may include at least one processor (or processing circuitry), and the at least one processor may perform the following operations individually, collectively or in any combination thereof. For example, the processor 108 may include a communication processor (CP) configured to control communication operations and an application processor (AP) configured to control execution of an upper layer (for example, an application layer). In a specific embodiment, at least a part of the processor 108 may be included in one chip and the other part of the processor 108 may be included in another chip. Otherwise, at least one processor may be included in another component, for example, the transceiver 106 or the memory 110.

The processor 108 may perform or control or cause an operation of the UE 102 for executing at least one or a combination of methods according to embodiments of the disclosure. To this end, the processor 108 may execute a computer program, codes, or instructions stored in the memory 110, so as to control other components of the UE 102 to enable execution of various operations.

FIG. 2 depicts a block diagram of a plurality of modules of a processor, according to an embodiment of the disclosure.

Referring to FIG. 2, the processor 108 further comprises a radio managing circuitry 202, a main radio (MR) 204, and a low-power radio (LR) 206.

In an embodiment herein, the radio managing circuitry 202 can transmit a UE capability information indicating support for a dual radio operation to the network 104. The UE capability information comprises an LR capability with at least one LR capability container. The radio managing circuitry 202 can transmit the UE capability information to the network 104, on receiving a UE capability enquiry for an LR support from the network 104. The UE capability information comprises a classification of the dual radio operation based on whether at least one of the MR 204, and the LR 206 operates on at least one of a same frequency band, and a different frequency band.

In an embodiment herein, the radio managing circuitry 202 can receive an LR configuration message from the network 104. The LR configuration message indicates an LR mode activation. In an embodiment herein, the radio managing circuitry 202 can transmit a UE assistance information including one or more LR capabilities to the network 104 for requesting an LR mode activation. The radio managing circuitry 202 can receive the LR configuration message from the network 104 indicating the LR mode activation, based on the UE assistance information. The LR configuration message comprises an LR configuration including at least one of a reduced bandwidth, and a reduced processing capability relative to the MR 204. The LR configuration message can include, but not limited to a radio resource control (RRC) release message, and an RRC reconfiguration message.

In an embodiment herein, the radio managing circuitry 202 can activate the LR 206, upon receiving the LR configuration message indicating the LR mode activation. In an embodiment herein, the radio managing circuitry 202 can receive an RRC reconfiguration message including a request for an LR measurement report from the network 104. The radio managing circuitry 202 can perform measurement on an LR band, and obtain the LR measurement report based on the received request. In an embodiment herein, the radio managing circuitry 202 can receive an LR measurement configuration from the network 104 for performing the measurement on the LR band. The LR measurement configuration can include, but not limited to a frequency, a waveform, and a periodicity required for performing the measurement. The radio managing circuitry 202 can transmit the LR measurement report to the network 104 from at least one of the MR 204, and the LR 206 of the UE 102. The radio managing circuitry 202 can receive an RRC request from the network 104 for activating the LR 206 based on the LR measurement report. Further, the radio managing circuitry 202 can activate the LR 206 by the MR 204, based on the received RRC request.

In an embodiment herein, the radio managing circuitry 202 can operate at least a portion of one or more communication functions using the activated LR 206. The UE 102 maintains communication with the network 104 using at least one of the MR 204, and the LR 206, based on the operation of at least a portion of the communication functions.

In an embodiment herein, the memory 110 corresponds to a hardware storage device capable of temporarily or permanently storing information and may include one or more storage media. For example, the memory 110 may include memory assembly including one or more storage media. For example, the one or more storage media may include permanent memory, such as a hard drive, flash memory, or read-only memory (ROM), semipermanent memory, such as random access memory (RAM), cache memory, or a combination thereof.

The memory 110 may be electrically, operatively, and/or communicatively coupled to the processor 108 and may be accessed by the processor 108.

The memory 110 may store a computer program, codes, or instructions executable by the processor 108. According to an embodiment, a computer program, codes, or instructions executable by the processor 108 may be either stored in a single memory device or separated and stored in a distributed manner in two or more memory devices. By executing the instructions stored in the memory 110, the processor 108 may perform various functions according to an embodiment of the disclosure.

In an embodiment herein, operations of the UE 102 may be caused to be performed based on execution of instructions (or a computer program or codes) stored in the memory 110 by at least one processor (or processing circuitry) configured to execute the same individually, collectively, or in any combination thereof, based on processing circuitry that is not configured to execute instructions, and/or based on components of processing circuitry that is not configured to execute instructions.

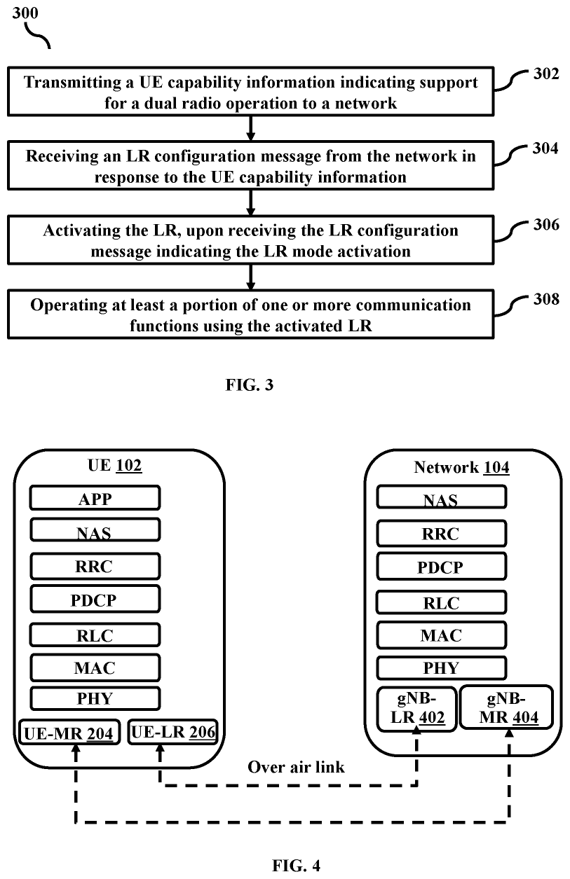

FIG. 3 depicts a method for performing the dual radio operation by the UE according to an embodiment of the disclosure.

Referring to FIG. 3, the method 300 comprises transmitting a UE capability information indicating support for the dual radio operation to the network 104, as depicted in operation 302. The method 300 comprises receiving an LR configuration message from the network 104 in response to the UE capability information, as depicted in operation 304. The LR configuration message indicates an LR mode activation. The method 300 comprises activating the LR 206, as depicted in operation 306, upon receiving the LR configuration message indicating the LR mode activation. Thereafter, the method 300 comprises operating at least a portion of one or more communication functions using the activated LR 206, as depicted in operation 308.

The various actions in method 300 may be performed in the order presented, in a different order or simultaneously. Further, in some embodiments, some actions listed in FIG. 3 may be omitted.

FIG. 4 depicts an example overview of the wireless communication network for performing dual radio operation according to an embodiment of the disclosure.

Referring to FIG. 4, a UE and a gNB connected to each other over an over-the-air link according to an embodiment of the disclosure. The UE 102 comprises a UE-MR or MR 204, and a UE-LR or LR 206. The gNB of the network 104 comprises a base station low-power radio (gNB-LR) 402, and a base station main radio (gNB-MR) 404. The UE-LR 206 can communicate with the gNB-LR 402 over an over-the-air link. The UE-MR 204 can communicate with the gNB-MR 404 over an over-the-air link.

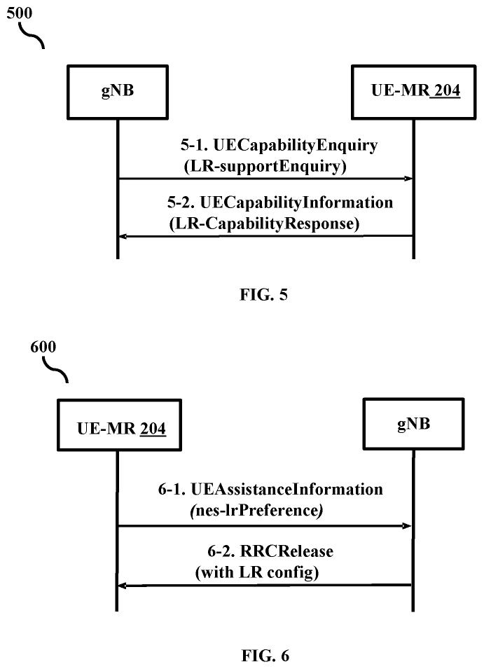

FIG. 5 depicts a method for indicating a UE LR capability according to an embodiment of the disclosure.

Referring to FIG. 5, in operation 5-1 of the method 500, the gNB transmits a UECapabilityEnquiry for LR-supportEnquiry to the UE-MR 204. The UE-MR 204 sends a UECapabilityInformation including an LR-CapabilityResponse to the gNB, as depicted in operation 5-2, for the received UECapabilityEnquiry. The UECapabilityInformation includes a UE-CapabilityLR-ContainerList. The UE-CapabilityLR-ContainerList includes:
nes-lpr (intra-LRMR, inter-LRMR, both)
LR capability which can be categorized based on operating frequency where,
LR and MR operates on same radio frequency (intra-LRMR)
LR and MR operates on different radio frequency (inter-LRMR)
LR and MR operates on same and radio frequency (both-Intra-Inter-LRMR)
nes-lprMeasConfig
lr-measSameAsMR: notify that LR is only capable of measuring LP new reference signal along side legacy signals
lr-measLPOnly: notify that LR is only capable of measuring LP new reference signal
both: UE which can support both kind of measurement

The method 500 includes adding LRSupport field (per band) along with supported band list in Uplink Control Information (UCI).

FIG. 6 depicts a method for requesting the network to configure energy saving feature according to an embodiment of the disclosure.

Referring to FIG. 6, in operation 6-1 of the method 600, the UE-MR 204 transmits a UEAssistanceInformation for nes-lprPreference-rXX to the gNB. The nes-lprPreference-rXX is Boolean optional. The gNB may accept to put the UE-MR 204 in LR mode by sending an RRCRelease with LR configuration to the UE-MR 204, as depicted in operation 6-2. The gNB may also reject the request by not sending the RRCRelease.

The RRCRelease message includes:

```
  -- ASN1START
  -- TAG-RRCRELEASE-START
  RRCRelease ::= SEQUENCE {
  rrc-TransactionIdentifier RRC-TransactionIdentifier,
  criticalExtensions CHOICE {
  - rrcRelease RRCRelease-IEs,
  - criticalExtensionsFuture SEQUENCE { }
  - }
  - }
  - RRCRelease-IEs ::= SEQUENCE {
  - redirectedCarrierInfo RedirectedCarrierInfo OPTIONAL, -- Need N
  - cellReselectionPriorities CellReselectionPriorities OPTIONAL, --
Need R
  - suspendConfig SuspendConfig OPTIONAL, -- Need R
  - deprioritisationReq SEQUENCE {
  - deprioritisationType ENUMERATED { frequency, nr},
  - deprioritisationTimer ENUMERATED {min5, min10, min15, min30}
  - lowpowerRFConfig
  - } OPTIONAL, -- Need N
  - lateNonCriticalExtension OCTET STRING OPTIONAL,
  - nonCriticalExtension RRCRelease-v1540-IEs OPTIONAL
  }
  lowpowerRFConfig {
  - LP_PagingCycle ::= ENUMERATED {rf32, rf64, rf128, rf256}
  - LP_WUS_Periodicity (in msec or lp-pdcch count)
  - LP_WUS_Waveform (traditional time domain On-Off Keying
(OOK), frequency domain OOK, or multi-tone signaling sequence)
  - LP_ CarrierInfoLR (ARFCN, cellSelectionCritria)
  - Measurement perioditicy (in msec)
```

The cellSelectionCriteria can be the minimum signal quality information for camping, Synchronization Signal Block (SSB) info detail.

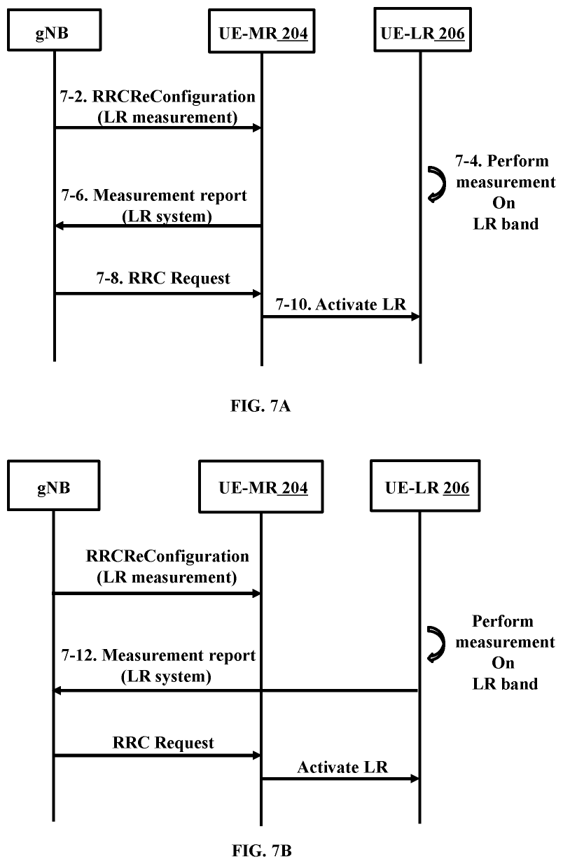

FIGS. 7A and 7B depict methods for performing measurement in dual radio devices according to various embodiments of the disclosure.

Referring to FIGS. 7A and 7B, if a device capability allows sending small data on the LR 206, then the UE 102 sends the measurement report using the LR 206. Else, the UE 102 turns on the MR 204, and sends the measurement report. Ability to send measurement via the LR 206 could help reduce the transitions from the LR 206 to the MR 204. Hence, it could reduce the transition signaling overhead.

For example, as depicted in operation 7-2, the gNB transmits an RRCReConfiguration to the UE-MR 204 requesting for an LR measurement. The UE-LR 206 performs measurement on LR band as depicted in operation 7-4. Later, the UE-MR 204 transmits a measurement report of the LR band to the gNB, as depicted in operation 7-6. The gNB sends an RRC request to the UE-MR 204, as depicted in operation 7-8, for activating the LR 206. Thereafter, the UE-MR 204 activates the LR 206, as depicted in operation 7-10.

However, if the UE capability allows sending small data on the LR 206, then the UE 102 sends the measurement report using the UE-LR 206, as depicted in operation 7-12 in the FIG. 7B.

If MR and LR bands are different, then the network 104 may first configure L3/lower layer triggered mobility (LTM)/conditional handover (CHO) measurement for the LR band. If the LR 206 uses different waveform than the MR 204, then the network 104 may additionally introduce a new measurement configuration of the LR 206. This can be configured in dedicated RRCReconfig in the MR 204. Embodiments herein add a new parameter in RRCReconfig for performing measurement of LR system. The measurement can be sent over a Signaling Radio Bearer 1(SRB1)/encapsulated SRB1 on the MR 204.

If the LR 206 supports sending measurement report, then the configuration for master information block (MIB)/SSB or reference signal on the LR 206 could be different than the MR system. Hence it is needed that the UE 102 is aware of measurement configuration.

The embodiments herein disclose a method 300 to inform the UE 102 about the measurement configuration. The LRConfig can be added in dedicated message in RRC (like measurement configuration) or via SIB1 over the MR 204 or RRCRelease. These LRConfig could be but not limited to,
absolute radio frequency channel number (ARFCN) (carrying information about frequency on which the LR should be measured); i.e.,
a waveform, carrying information about what waveform LR should be decoding signal; and
periodicity, carrying information about at what periodicity should LR attempt to perform measurement.
Such LR measurement information can be shared for multiple ARFCN as list.

The methods 300 distinguish between LR capable devices from legacy devices. The methods 300 allow the network 104 to identify various categories of LR capable device that may operate in the network 104. The methods 300 allow the UE 102, and the network 104 to configure network energy saving techniques efficiently by determining the category of the UE 102. The methods 300 help LR capable to co-exists with legacy devices, and allow the network 104 to take better decisions to activate/deactivate network energy saving features.

By designing the dual-radio architecture that aligns with sustainability principles, a more energy-efficient and environmentally friendly wireless communication system can be obtained. This approach reduces energy consumption, and optimizes the efficient use of resources, ultimately contributing to a more sustainable future.

While the disclosure has been shown and described with reference to various embodiments thereof, it will be understood by those skilled in the art that various changes in form and details may be made therein without departing from the spirit and scope of the disclosure as defined by the appended claims and equivalents. What is claimed is:

1. A method for performing a dual radio operation in a wireless communication system, comprising:
transmitting, by a user equipment (UE), a UE capability information indicating support for the dual radio operation to a network, wherein the UE capability information comprises a low-power radio (LR) capability with at least one LR capability container;
receiving, by the UE, an LR configuration message from the network, wherein the LR configuration message indicates an LR mode activation;
activating, by the UE, an LR, based on receiving the LR configuration message indicating the LR mode activation; and
operating, by the UE, at least a portion of one or more communication functions using the activated LR.

2. The method as claimed in claim 1,
transmitting, by the UE, the UE capability information to the network, on receiving a UE capability enquiry for an LR support from the network, and
wherein the UE capability information comprises:
a classification of the dual radio operation based on whether at least one of a main radio (MR), and
the LR operates on at least one of a same frequency band, and a different frequency band.

3. The method as claimed in claim 1, wherein the receiving of the LR configuration message from the network, comprises:
transmitting, by the UE, a UE assistance information including one or more LR capabilities to the network for requesting an LR mode activation; and
receiving, by the UE, the LR configuration message from the network indicating the LR mode activation, based on the UE assistance information.

4. The method as claimed in claim 1,
wherein the LR configuration message comprises:
an LR configuration including at least one of a reduced bandwidth, and
a reduced processing capability relative to the MR, and
wherein the LR configuration message comprises:
at least one of a radio resource control (RRC) release message, and
an RRC reconfiguration message.

5. The method as claimed in claim 1, further comprising:
receiving, by the UE, the RRC reconfiguration message including a request for an LR measurement report from the network;
performing, by the UE, measurement on an LR band, and obtaining the LR measurement report based on the received request;
transmitting, by the UE, the LR measurement report to the network from at least one of the MR, and the LR of the UE;
receiving, by the UE, an RRC request from the network for activating the LR based on the LR measurement report; and
activating, by the UE, the LR by the MR, based on the received RRC request.

6. The method as claimed in claim 5,
wherein the UE receives an LR measurement configuration from the network for performing the measurement on the LR band, and
wherein the LR measurement configuration comprises at least one of a frequency, a waveform, and a periodicity required for performing the measurement.

7. The method as claimed in claim 1, wherein the UE maintains communication with the network using at least one of the MR, and the LR based on the operation of at least a portion of the one or more communication functions.

8. A user equipment (UE), comprising:
a transceiver configured to receive and transmit a signal;
memory, comprising one or more storage media, storing instructions; and
one or more processors communicatively coupled to the transceiver and the memory, wherein the instructions, when executed by the one or more processors individually or collectively, cause the UE to:
transmit a UE capability information indicating support for a dual radio operation to a network, wherein the capability information comprises a low-power radio (LR) capability with at least one LR capability container;
receive an LR configuration message from the network, wherein the LR configuration message indicates an LR mode activation;
activate an LR, based on receiving the LR configuration message indicating the LR mode activation; and
operate at least a portion of one or more communication functions using the activated LR.

9. The UE as claimed in claim 8,
wherein the instructions, when executed by the one or more processors individually or collectively, further cause the UE to transmit the UE capability information to the network, on receiving a UE capability enquiry for an LR support from the network,
wherein the UE capability information comprises:
a classification of the dual radio operation based on whether at least one of a main radio (MR), and
the LR operates on at least one of a same frequency band, and a different frequency band.

10. The UE as claimed in claim 8, wherein the instructions, when executed by the one or more processors individually or collectively further cause the UE to:
transmit a UE assistance information including one or more LR capabilities to the network for requesting an LR mode activation; and
receive the LR configuration message from the network indicating the LR mode activation, based on the UE assistance information.

11. The UE as claimed in claim 8,
wherein the LR configuration message comprises:
an LR configuration including at least one of a reduced bandwidth, and
a reduced processing capability relative to the MR, and
wherein the LR configuration message comprises:
at least one of a radio resource control (RRC) release message, and
an RRC reconfiguration message.

12. The UE as claimed in claim 8, wherein the instructions, when executed by the one or more processors individually or collectively, cause the UE to:
receive the RRC reconfiguration message including a request for an LR measurement report from the network;
perform measurement on an LR band, and obtain the LR measurement report based on the received request;
transmit the LR measurement report to the network from at least one of the MR, and the LR of the UE;
receive an RRC request from the network for activating the LR based on the LR measurement report; and
activate the LR by the MR, based on the received RRC request.

13. The UE as claimed in claim 12,
wherein the instructions, when executed by the one or more processors individually or collectively, further cause the UE to receive an LR measurement configuration from the network for performing the measurement on the LR band, and
wherein the LR measurement configuration comprises at least one of a frequency, a waveform, and a periodicity required for performing the measurement.

14. The UE as claimed in claim 8, wherein the instructions, when executed by the one or more processors individually or collectively, further cause the UE to maintain communication with the network using at least one of the MR, and the LR, based on the operation of at least a portion of the one or more communication functions.

15. The UE as claimed in claim 12, wherein the receiving of the RRC reconfiguration message comprises receiving the RRC reconfiguration message including the request for the LR measurement report from the network via the MR.

16. The UE as claimed in claim 8, wherein instructions, when executed by the one or more processors individually or collectively, further cause the UE to, when the UE capability allows sending small data on the LR, then send the LR measurement report using the LR of the UE.

17. One or more non-transitory computer-readable storage media storing one or more computer programs including computer-executable instructions that, when executed by one or more processors of an electronic device individually or collectively, cause the electronic device to perform operations, the operations comprising:
transmitting, by a user equipment (UE), a UE capability information indicating support for a dual radio operation to a network, wherein the UE capability information comprises a low-power radio (LR) capability with at least one LR capability container;
receiving, by the UE, an LR configuration message from the network, wherein the LR configuration message indicates an LR mode activation;
activating, by the UE, an LR, based on receiving the LR configuration message indicating the LR mode activation; and
operating, by the UE, at least a portion of one or more communication functions using the activated LR.

18. The one or more non-transitory computer-readable storage media of claim 17, wherein the operation of receiving the LR configuration message from the network, comprises:
transmitting, by the UE, a UE assistance information including one or more LR capabilities to the network for requesting an LR mode activation; and
receiving, by the UE, the LR configuration message from the network indicating the LR mode activation, based on the UE assistance information.

19. The one or more non-transitory computer-readable storage media of claim 17, wherein the operation of activating the LR by the MR, comprises;
receiving, by the UE, the RRC reconfiguration message including a request for an LR measurement report from the network;
performing, by the UE, measurement on an LR band, and obtaining the LR measurement report based on the received request;
transmitting, by the UE, the LR measurement report to the network from at least one of the MR, and the LR of the UE;
receiving, by the UE, an RRC request from the network for activating the LR based on the measurement report; and
activating, by the UE, the LR by the MR, based on the received RRC request.

20. The one or more non-transitory computer-readable storage media of claim 17, comprises:
maintaining communication with the network using at least one of the MR, and the LR, based on the operation of at least a portion of the one or more communication functions.
